(19) United States
(12) Patent Application Publication
(10) Pub. No.: US 2003/0134999 A1
(43) Pub. Date: Jul. 17, 2003

(54) Method for polymerizing conjugated diolefins (dienes) with rare earth catalysts in the presence of vinylaromatic solvents

(76) Inventors: Heike Windisch, Leverkusen (DE); Werner Obrecht, Moers (DE); Gisbert Michels, Koln (DE); Norbert Steinhauser, Monheim (DE); Thomas Schnieder, Dormagen (DE)

Correspondence Address: BAYER POLYMERS LLC, 100 BAYER ROAD, PITTSBURGH, PA, 15205, US

(21) Appl. No.: 10/346,841

(22) Filed: Jan. 17, 2003

Related U.S. Application Data
(62) Division of application No. 09/743,597, filed on Jan. 11, 2001.

(30) Foreign Application Priority Data
Jul. 18, 1998 (DE) 198 32 446.4

(51) Int. Cl. C08F 4/44; C08F 236/00; C08F 212/06

(52) U.S. Cl. 526/188; 526/340; 526/347

(57) ABSTRACT

Conjugated diolefins, optionally in combination with other unsaturated compounds which may be copolymerised with the diolefins, are polymerised by performing the polymerisation of the diolefins in the presence of catalysts based on rare earth compounds, cyclopentadienes and organoaluminium compounds in the presence of aromatic vinyl compounds as the solvent at temperatures of −30 to +100° C.

By means of the process according to the invention, it is possible straightforwardly to produce solutions of copolvmers, such as of styrene/butadiene copolymers, having a differing styrene content and also having, relative to the diolefin, differing 1,2 and cis unit contents, in aromatic vinyl compounds, which solutions may then, for example, be further processed to yield ABS or HIPS.

This invention relates to a process for the polymerisation of conjugated diolefins in the presence of rare earth catalysts and in the presence of aromatic vinyl compounds.

It has long been known to polymerise conjugated dienes in the presence of a solvent and such polymerisation has been described, for example, by W. Hoffmann, Rubber Technology Handbook, Hanser Publishers (Carl Hanser Verlag), Munich, Vienna, New York, 1989. Polybutadiene, for example, is accordingly now predominantly produced by solution polymerisation using coordination catalysts of the Zielger/Natta type, for example based on titanium, cobalt, nickel and neodymium compounds, or in the presence of alkyllithium compounds. The solvent used in each case is highly dependent upon the type of catalyst used. Benzene or toluene as well as aliphatic or cycloaliphatic hydrocarbons are preferably used.

A disadvantage of currently performed polymerisation processes for the production of polydiolefins, such as for example BR, IR, SBR, is the elaborate working up of the polymer solution to isolate the polymers, for example by steam stripping or direct evaporation. A further disadvantage, especially if the polymerised diolefins are to be further processed as impact modifiers for plastics applications, is that the resultant polymeric diolefins must initially be redissolved in a new solvent, for example styrene, so that they may be further processed to yield, for example, acrylonitrile/butadiene/styrene copolymer (ABS) or high impact polystyrene (HIPS).

U.S. Pat. No. 3,299,178 claims a catalyst system based on TiCl₄/iodine/Al(iso-Bu)₃ for the polymerisation of butadiene in styrene to form homogeneous polybutadienes. Harwart et al., Pláste und Kautschuk, 24/8 (1977) 540, describe the copolymerisation of butadiene and styrene using the same catalyst system and the suitability of the catalyst for the production of polystyrene.

U.S. Pat. No. 5,096,970 and EP 304088 describe a process for the production of polybutadiene in styrene using catalysts based on neodymium phosphonates, on organic aluminium compounds, such as di(isobutyl)aluminium hydride (DIBAH), and based on a Lewis acid containing halogen, such as ethylaluminium sesquichloride, in which butadiene is reacted in styrene without further addition of inert solvents to yield a 1,4-cis-polybutadiene. A disadvantage of this catalyst is that the resultant polymers have a very low content of 1,2 units of below 1%. This is disadvantageous because a higher 1,2 content in polymers has a favourable effect on the bond between rubber and the polymer matrix, for example homo- or copolymers of vinyl aromatic compounds.

It is known from U.S. Pat. No. 4,311,819 to use anionic initiators for the polymerisation of butadiene in styrene. According to the patent Examples, it was possible to obtain an SBR rubber suitable for use in HIPS either by terminating the polymerisation, given an initial concentration of butadiene in styrene of approx. 35 wt. %, at a butadiene monomer conversion of only approx. 25%, or by increasing the butadiene monomer conversion to approx. 36% by an elevated butadiene concentration of approx. 55 wt. %, such that the majority of the butadiene must in either case be removed by distillation before further use is made of the rubber solution in styrene for impact modification.

The disadvantage of the anionic initiators is that they result in the formation of butadiene/styrene copolymers (SBR) which, in relation to the butadiene units, permit only slight control of microstructure. It is not possible using anionic initiators to produce an SBR having an elevated cis content in which the 1,4-cis content is above 40%. It is only possible to increase the proportion of 1,2 or 1,4-trans units by adding modifiers, wherein the 1,2 content above all results in an increase in the glass transition temperature of the polymer. This fact is primarily disadvantageous because SBR is formed in this process in which, in comparison with homopolymeric polybutadiene (BR), a rising styrene content results in a further increase in the glass transition temperature. However, if the rubber is to be used for impact modification of for example HIPS or ABS, an elevated glass transition temperature of the rubber has a disadvantageous effect on the low temperature toughness of the material, such that rubbers having low glass transition temperatures are preferred.

Kobayashi et al, J. Polym. Sci., Part A, Polym. Chem., 33 (1995) 2175 and 36 (1998) 241 have described a catalyst system consisting of halogenated rare earth acetates, such as for example Nd(OCOCCl₃)₃ or Gd(OCOCF₃)₃, with tri(isobutyl)aluminium and diethylaluminium chloride, which allows the copolymerisation of butadiene and styrene in the inert solvent hexane. Apart from the presence of inert solvents, the disadvantage of these catalysts is that, at a styrene incorporation of as little as approx. 5 mol. %, the catalyst activity falls to below 10 g of polymer/mmol. of catalyst/h and that the 1,4-cis content of the polymer falls distinctly as the styrene content rises.

The advantage of SBR over pure BR for use in modifying plastics, for example as impact modifiers for ABS and HIPS, is that as the styrene content rises, the refractive indices of the rubber and matrix come closer together, so improving the transparency of the modified plastics. On the other hand, the glass transition temperature of the rubber increases with a rising styrene content, which then has a negative effect on the impact strength of the plastic.

The rubber solutions in styrene described in the stated patent publications were used for the production of HIPS by combining the rubber solutions in styrene with free-radical initiators once the unreacted diolefin had been removed.

On the other hand, the rubber is used in a matrix of acrylonitrile/styrene copolymer (SAN) in order to produce ABS. In contrast with the production of HIPS, the SAN matrix in ABS is incompatible with polystyrene. If homopolymers of the solvent, such as polystyrene, are formed as well as the rubber, when the diolefins are polymerised in vinyl aromatic solvents, the incompatibility of the SAN matrix with the polymerised vinyl aromatics results during the production of ABS in a considerable impairment of the material properties of the ABS.

The object of the present invention was accordingly to provide a process for the polymerisation of conjugated diolefins in vinyl aromatic solvents, by means of which copolymers are obtained in which the polymer composition may be varied with regard to the content of vinyl aromatics and diolefins and with regard to the selectivity of the polymerised diolefins, i.e. for example content of double bonds in cis position and of 1,2 units with lateral vinyl groups, wherein the glass transition temperature of the polymer is below −60° C., preferably below −70° C.

The present invention accordingly provides a process for the copolymerisation of conjugated dienes with vinyl aromatic compounds, which process is characterised in that polymerisation of the conjugated dienes is performed in the presence of catalysts consisting of

a) at least one rare earth metal compound,

b) at least one cyclopentadiene and

c) at least one organoaluminium compound or consisting of

a) at least one rare earth metal compound and

c) at least one organoaluminium compound as well as in the presence of vinyl aromatic compounds at temperatures of −30 to +100° C., wherein the molar ratio of components (a):(b):(c) is in the range from 1:0.01-1.99:0.1-1000 or wherein the molar ratio of components (a):(c) is in the range from 1:0.1-1000, component (a) of the catalyst is used in quantities of 1 μmol. to 10 mmol., relative to 100 g of the conjugated diolefins used, and the aromatic vinyl compound is used in quantities of 50 g to 2000 g, relative to 100 g of the conjugated diolefins used.

Conjugated diolefins (dienes) which may be used in the process according to the invention are, for example 1,3-butadiene, 1,3-isoprene, 2,3-dimethylbutadiene, 2,4-hexadiene, 1,3-pentadiene and/or 2-methyl-1,3-pentadiene.

It is, of course, also possible in the process according to the invention additionally to use, as well as the conjugated diolefins, further unsaturated compounds, such as ethylene, propene, 1-butene, 1-pentene, 1-hexene and/or 1-octene, preferably ethylene and/or propene, which may be copolymerised with the stated diolefins.

The quantity of unsaturated compounds which may be copolymerised with the conjugated diolefins is dependent upon the particular intended application of the desired copolymers and may readily be determined by appropriate preliminary testing. It is conventionally 0.1 to 80 mol. %, preferably 0.1 to 50 mol. %, particularly preferably 0.1 to 30 mol. %, relative to the diolefin.

The molar ratio of components (a):(b):(c) in the catalyst used is preferably in the range from 1:0.1-1.9:3-500, particularly preferably 1:0.2-1.8:5-100. The molar ratio of component (a):(c) is preferably in the range from 1:3-500, in particular 1:5-100.

Rare earth metal compounds (component (a)) which may in particular be considered are those selected from among

a rare earth metal alkoxide,

a rare earth metal phosphonate, phosphinate and/or phosphate,

a rare earth metal carboxylate,

a rare earth metal complex compound with diketones and/or

an addition compound of rare earth metal halides with an oxygen or nitrogen donor compound.

The above-stated rare earth metal compounds are described, for example, in EP 11184.

The rare earth metal compounds are in particular based on the elements having the atomic numbers 21, 39 and 57 to 71. Preferably used rare earth metals are lanthanum, praseodymium or neodymium or a mixture of rare earth metal elements which contains at least 10 wt. % of at least one of the elements lanthanum, praseodymium or neodymium. Very particularly preferably used rare earth metals are lanthanum or neodymium, which may in turn be blended with other rare earth metals. The proportion of lanthanum and/or neodymium in such a mixture is particularly preferably at least 30 wt. %.

Rare earth metal alkoxides, phosphonates, phosphinates and carboxylates or rare earth metal complex compounds with diketones which may in particular be considered are those in which the organic group present in the compounds in particular contains linear or branched alkyl residues having 1 to 20 carbon atoms, preferably 1 to 15 carbon atoms, such as methyl, ethyl, n-propyl, n-butyl, n-pentyl, isopropyl, isobutyl, tert.-butyl, 2-ethylhexyl, neopentyl, neooctyl, neodecyl or neododecyl.

Rare earth alkoxides which may, for example, be mentioned are: neodymium(III) n-propanolate, neodymium(III) n-butanolate, neodymium(III) n-decanolate, neodyrnium(III) isopropanolate, neodymium(III) 2-ethylhexanolate, praseodymium(III) n-propanolate, praseodymium(III) n-butanolate, praseodymium(III) n-decanolate, praseodymium(III) isopropanolate, praseodymium(III) 2-ethylhexanolate, lanthanum(III) n-propanolate, lanthanum(III) n-butanolate, lanthanum(III) n-decanolate, lanthanum(III) isopropanolate and lanthanum(III) 2-ethylhexanolate, preferably neodymium(III) n-butanolate, neodymium(III) n-decanolate and neodymium(III) 2-ethylhexanolate.

Rare earth phosphonates, phosphinates and phosphates which may, for example be mentioned are: neodymium(III) dibutylphosphonate, neodymium(III) dipentylphosphonate, neodymium(III) dihexylphosphonate, neodymium(III) diheptylphosphonate, neodymium(III) dioctylphosphonate, neodymium(III) dinonylphosphonate, neodymium(III) didodecylphosphonate, neodymium(III) dibutylphosphinate, neodymium(III) dipentylphosphinate, neodymium(III) dihexylphosphinate, neodymium(III) diheptylphosphinate, neodymium(III) dioctylphosphinate, neodymium(III) dinonylphosphinate, neodymium(III) didodecylphosphinate and neodymium(III) phosphate, preferably neodymium(III) dioctylphosphonate and neodymium(III) dioctylphosphinate.

Suitable rare earth metal carboxylates are: lanthanum(III) propionate, lanthanum(III) diethylacetate, lanthanum(III) 2-ethylhexanoate, lanthanum(III) stearate, lanthanum(III) benzoate, lanthanum(III) cyclohexanecarboxylate, lanthanum(III) oleate, lanthanum(III) versatate, lanthanum(III) nap hthenate, praseodymium(III) propionate, praseodymium(III) diethylacetate, praseodymium(III) 2-ethylhexanoate, praseodymium(III) stearate, praseodymium(III) benzoate, praseodymium(III) cyclohexanecarboxylate, praseodymium(III) oleate, praseodymium(III) versatate, praseodymium(III) naphthenate, neodymium(III) propionate, neodymium(III) diethylacetate, neodymium(III) 2-ethylhexanoate, neodymium(III) stearate, neodymium(III) benzoate, neodymium(III) cyclohexanecarboxylate, neodymium(III) oleate, neodymium(III) versatate and neodymium(III) naphthenate, preferably neodymium(III) 2-ethylhexanoate, neodymium(III) versatate and neodymium(III) naphthenate. Neodymium versatate is particularly preferred.

Rare earth metal complex compounds with diketones which may be mentioned are: lanthanum(III) acetylacetonate, praseodymium(III) acetylacetonate and neodymium(III) acetylacetonate, preferably neodymium(III) acetylacetonate.

Addition compounds of rare earth metal halides with an oxygen or nitrogen donor compound which may, for example, be mentioned are: lanthanum(III) chloride with tributyl phosphate, lanthanum(III) chloride with tetrahydrofuran, lanthanum(III) chloride with isopropanol, lanthanum(III) chloride with pyridine, lanthanum(III) chloride with 2-ethylhexanol, lanthanum(III) chloride with ethanol, praseodymium(III) chloride with tributyl phosphate, praseodymium(III) chloride with tetrahydrofuran, praseodymium(III) chloride with isopropanol, praseodymium(III) chloride with pyridine, praseodymium(III) chloride with 2-ethylhexanol, praseodymium(III) chloride with ethanol, neodymium(III) chloride with tributyl phosphate, neodymium(III) chloride with tetrahydrofuran, neodymium(III) chloride with isopropanol, neodymium(III) chloride with pyridine, neodymium(III) chloride with 2-ethylhexanol, neodymium(III) chloride with ethanol, lanthanum(III) bromide with tributyl phosphate, lanthanum(III) bromide with tetrahydrofuran, lanthanum(III) bromide with isopropanol, lanthanum(III) bromide with pyridine, lanthanum(III) bromide with 2-ethylhexanol, lanthanum(III) bromide with ethanol, praseodymium(III) bromide with tributyl phosphate, praseodymium(III) bromide with tetrahydrofuran, praseodymium(III) bromide with isopropanol, praseodymium(III) bromide with pyridine, praseodymium(III) bromide with 2-ethylhexanol, praseodymium(III) bromide with ethanol, neodymium(III) bromide with tributyl phosphate, neodymium(III) bromide with tetrahydrofuran, neodymium(III) bromide with isopropanol, neodymium(III) bromide with pyridine, neodymium(III) bromide with 2-ethylhexanol and neodymium(III) bromide with ethanol, preferably lanthanum(III) chloride with tributyl phosphate, lanthanum(III) chloride with pyridine, lanthanum(III) chloride with 2-ethylhexanol, praseodymium(III) chloride with tributyl phosphate, praseodymium(III) chloride with 2-ethylhexanol, neodymium(III) chloride with tributyl phosphate, neodymium(III) chloride with tetrahydrofuran, neodymium(III) chloride with 2-ethylhexanol, neodymium(III) chloride with pyridine, neodymium(III) chloride with 2-ethylhexanol and neodymium(III) chloride with ethanol.

Very particularly preferably used rare earth metal compounds are neodymium versatate, neodymium octanoate and/or neodymium naphthenate.

The above-stated rare earth metal compounds may be used both individually and mixed together. The most favourable mixing ratio may readily be determined by appropriate preliminary testing.

The cyclopentadienes (component (b)) used are compounds of the formulae (I), (II) or (III)

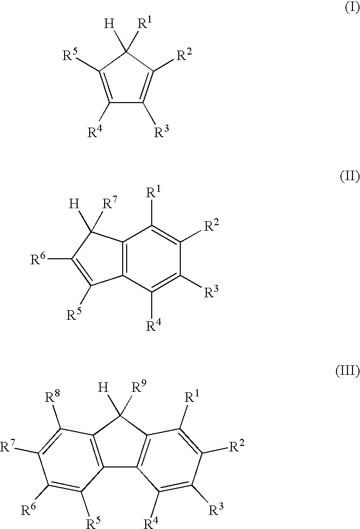

in which R¹ to R⁹ are identical or different or are optionally joined together or are fused on the cyclopentadiene of the formula (I), (II) or (III) and may denote hydrogen, a C₁-C₃₀ alkyl group, a C₆-C₁₀ aryl group, a C₇-C₄₀ alkylaryl group and a C₃-C₃₀ silyl group, wherein the alkyl groups may be either saturated or mono- or polyunsaturated and may contain heteroatoms such as oxygen, nitrogen or halides. The residues may in particular denote hydrogen, methyl, ethyl, n-propyl, isopropyl, n-butyl, isobutyl, tert.-butyl, phenyl, methylphenyl, cyclohexyl, benzyl, trimethylsilyl or trifluoromethyl.

Examples of cyclopentadienes are unsubstituted cyclopentadiene, methylcyclopentadiene, ethylcyclopentadiene, n-butylcyclopentadiene, tert.-butylcyclopentadiene, vinylcyclopentadiene, benzylcyclopentadiene, phenylcyclopentadiene, trimethylsilylcyclopentadiene, 2-methoxyethylcyclopentadiene, 1,2-dimethylcyclopentadiene, 1,3-dimethylcyclopentadiene, trimethylcyclopentadiene, tetramethylcyclopentadiene, tetraphenylcyclopentadiene, tetrabenzylcyclopentadiene, pentamethylcycylopentadiene, pentabenzylcyclopentadiene, ethyltetramethylcyclopentadiene, trifluoromethyl-tetramethylcyclopentadiene, indene, 2-methylindenyl, trimethylindene, hexamethyl-indene, heptamethylindene, 2-methyl-4-phenylindenyl, fluorene or methylfluorene.

The cyclopentadienes may also be used individually or mixed together.

Organoaluminium compounds (component (c)) which may in particular be considered are alumoxanes and/or aluminiumorganyl compounds.

The alumoxanes used are aluminium/oxygen compounds which, as is known to the person skilled in the art, are obtained by bringing organoalumium compounds into contact with condensing components, such as for example water, and which constitute acyclic or cyclic compounds of the formula (—Al(R)O—)ₙ, wherein R may be identical or different and denotes a linear or branched alkyl group having 1 to 10 carbon atoms, which may additionally contain heteroatoms, such as for example oxygen or nitrogen. R in particular denotes methyl, ethyl, n-propyl, isopropyl, n-butyl, isobutyl, tert.-butyl, n-octyl or isooctyl, particularly preferably methyl, ethyl or isobutyl. Examples of alumoxanes which may be mentioned are: methylalumoxane, ethylalumoxane and isobutylalumoxane, preferably methylalumoxane and isobutylalumoxane.

The aluminiumorganyl compounds used are compounds of the formula AlR_{3-d}X_{d}, wherein

R may be identical or different and may denote a C₁-C₁₀ aryl group and a C₇-C₄₀ alkylaryl group, wherein the alkyl groups may be either saturated or monounsaturated and may contain heteroatoms, such as oxygen or nitrogen,

X denotes a hydrogen, an alkoxide, phenolate or amide and

d means a number from 0 to 2.

Organoaluminium compounds of the formula AlR_{3-d}X_{d} which may in particular be used are: trimethylaluminium, triethylaluminium, tri-n-propylaluminium, triiisopropylaluminium, tri-n-butylaluminium, triisobutylaluminium, tripentylaluminium, trihexylaluminium, tricyclohexylaluminium, trioctylaluminium, diethylaluminium hydride, di-n-butylaluminium hydride, diisobutylaluminium hydride, diethylaluminium butanolate, diethylaluminiummethylidene(dimethyl)amine and diethylaluminiummethylidene(methyl) ether, preferably trimethylaluminium, triethylaluminium, triisobutylaluminium and diisobutylaluminium hydride.

The organoaluminium compounds may again be used individually or mixed together.

A further component (d) may also be added to the catalyst components (a) to (c). This component (d) may be a conjugated diene, which is for example the same diene which is subsequently to be polymerised with the catalyst. Butadiene and/or isoprene are preferably used.

If component (d) is added to the catalyst, the quantity of (d) is preferably 1 to 1000 mol. relative to 1 mol. of component (a), particularly preferably 1 to 100 mol. Very particularly preferably, 1-50 mol. of (d) are used relative to 1 mol. of component (a).

In the process according to the invention, the catalysts are used in quantities of preferably 10 μmol. to 5 mmol. of component (a), particularly preferably of 20 μmol. to 1 mmol. of component (a), relative to 100 g of the monomers.

It is, of course, also possible to use the catalysts in any desired mixture with each other.

The process according to the invention is performed in the presence of aromatic vinyl compounds, in particular in the presence of styrene, α-methylstyrene, α-methylstyrene dimer, p-methylstyrene, divinylbenzene and/or other alkylstyrenes having 2 to 6 C atoms in the alkyl residue, such as ethylbenzene.

The polymerisation according to the invention is very particularly preferably performed in the presence of styrene, α-methylstyrene, α-methylstyrene dimer and/or p-methylstyrene as solvent.

The solvents may be used individually or as a mixture; the most favourable mixing ratio may readily be determined by appropriate preliminary testing.

The quantity of aromatic vinyl compounds used is preferably 30 to 1000 g, very particularly preferably 50 to 500 g, relative to 100 g of monomers used.

The process according to the invention is preferably performed at temperatures of −20 to 90° C., particularly preferably at temperatures of 20 to 80° C.

The process according to the invention may be performed without pressure or at elevated pressure (0.1 to 12 bar).

The process according to the invention may be implemented continuously or discontinuously, preferably with continuous operation.

The solvent used in the process according to the invention need not be removed by distillation, but may instead remain in the reaction mixture. In this manner, it is possible, for example when styrene is used as the solvent, subsequently to perform a second polymerisation for the styrene, wherein an elastomeric polydiene in a polystyrene matrix is obtained. Similarly, acrylonitrile may be added to the polydiene solution in styrene before the second polymerisation is performed. In this manner, ABS is obtained. Such products are of particular interest as impact-modified thermoplastics.

It is, of course, also possible to remove a proportion of the solvent used and/or of the unreacted monomers after polymerisation, preferably by distillation optionally under reduced pressure, in order to achieve the desired polymer concentration.

Further components, for example unsaturated organic compounds, such as acrylonitrile, methyl methacrylate, maleic anhydride or maleimides, which may be copolymerised with the vinyl aromatic solvent, and/or usual aliphatic or aromatic solvents, such as benzene, toluene, dimethylbenzene, ethylbenzene, hexane, heptane or octane, and/or polar solvents, such as ketones, ethers or esters, which are conventionally used as solvents and/or diluents for the polymerisation of the vinyl aromatic solvent, may furthermore be added to the polymer solution before or during the subsequent polymerisation of the solvent, which may be initiated in a known manner, for example by free-radical or thermal means.

As has already been mentioned above, the process according to the invention is distinguished by particular economic viability and good environmental compatibility, as the solvent used may be polymerised in a subsequent stage, wherein the polymer present in the solvent serves to modify thermoplastics (for example to increase impact strength).

In the process according to the invention, the composition and thus the properties of the resultant polymers may be varied very widely.

For example, by varying the substituents of the cyclopentadiene used, it is possible to influence the microstructure of the resultant copolymers; for example the content of 1,2 units, i.e. of lateral double bonds in the polymer chain, and the content of double bonds in 1,4-cis position in the polymer chain. The nature of the substitution of the cyclopentadiene used furthermore influences copolymerisation parameters, in particular with regard to the diolefins and vinyl aromatic solvents used. For example, the content of vinyl aromatics in the resultant polymer may be influenced in this manner by varying the catalyst composition.

It is furthermore possible to influence polymer composition by varying the reaction conditions, such as by varying the ratio of diolefins and vinyl aromatic solvents used, the catalyst concentration, the reaction temperature and reaction time.

Another advantage of the process according to the invention is that, in the case of direct polymerisation in styrene, it is also possible to produce and straightforwardly further process low molecular weight polymers of such a low molecular weight that, as solids having elevated cold flow or elevated tackiness, they could be processed and stored only with difficulty.

The advantage of low molecular weight polymers is that, even at an elevated polymer content, the solution viscosity remains as low as desired and the solutions may consequently readily be conveyed and processed.

Using the process according to the invention, it is possible by polymerising diolefins in vinyl aromatic solvents to obtain copolymers of diolefins and vinyl aromatics, which, in contrast with anionic initiators, have an elevated content of 1,4-cis double bonds relative to the diolefin content and which furthermore allow simple control of microstructure, i.e. the content of lateral 1,2 and 1,4-cis units, polymer composition and molecular weight while elevated catalyst activity and elevated conversion of the diolefins used are simultaneously achieved.

### EXAMPLES

The polymerisation reactions were performed in the absence of air and moisture under argon. The isolation of the polymers from the solution in styrene described in individual Examples was performed solely for the purpose of characterising the polymers obtained. The polymers may, of course, also be stored and appropriately further processed in the solution in styrene without being isolated.

The styrene used as the solvent for the diolefin polymerisations was stirred under argon for 24 hours over CaH₂ at 25° C. and distilled at 25° C. under reduced pressure (Examples 1 to 16). In order to demonstrate that polymerisation is also possible with stabilised styrene, in some of the Examples the styrene was dried for 2 days over molecular sieve 4A (Baylith) and the polymerisation performed in the presence of the stabiliser (bis(tert.-butyl)pyrocatechol, 15 ppm) (Examples 17-19).

The styrene content in the polymer is determined by ¹H-NMR spectroscopy, polybutadiene selectivity (1,4-cis, 1,4-trans and 1,2 content) is determined by IR spectroscopy, the solution viscosity in a 5 wt. % solution of the polymer in styrene is determined by an Ubbelohde viscosimeter at 25° C., the glass transition temperature T_{g} is determined by DSC and the water content is determined by Carl-Fischer titration.

### Examples 1 to 5

Catalyst Ageing

7.2 g of butadiene, 0.57 ml of indene and 88.6 ml of a 10% solution of methylalumoxane in toluene (MAO) were added at 25° C. through a septum to 20 ml of a 0.245 molar solution of neodymium(III) versatate (NDV) in hexane in a 100 ml Schlenk tube, maintained at 50° C. with stirring for 2 hours and used for the polymerisation.

Polymerisation

Polymerisation proceeded in a 0.5 litre flask, which was provided with a crown cork with an integral septum. The stated quantity of liquid butadiene was added to the initially introduced styrene under argon through a cannula and the stated quantities of a 1 molar solution of tri(isobutyl)aluminium in toluene (TIBA) as scavenger and the aged catalyst solution were then added with a syringe. The temperature during the polymerisation was established by a water bath. After the stated reaction time, the polymer was isolated by precipitating the polymer solution in methanol/BKF (BKF=bis[(3-hydroxy)(2,4-di-tert.-butyl)(6-methyl)phenyl]methane) and dried for one day in a vacuum drying cabinet at 60° C. Table 1 shows the batch sizes, reaction conditions and the properties of the polymers obtained.

TABLE 1
Examples 1 to 5

| Example | 1 | 2 | 3 | 4 | 5 |
|---|---|---|---|---|---|
| Catalyst solution in ml | 4.91 | 4.91 | 2.46 | 2.21 | 3.68 |
| NDV in mmol. | 0.2 | 0.2 | 0.1 | 0.09 | 0.15 |
| Polymerisation | | | | | |
| Styrene in ml | 40 | 75 | 75 | 100 | 100 |
| 1,3-butadiene in g | 10.7 | 21.0 | 19.5 | 15.6 | 25.6 |
| TIBA (1 molar) in ml | — | — | — | 0.9 | 1.5 |
| Temperature in ° C. | 40 | 50 | 40 | 50 | 50 |
| Reaction time in h | 3.2 | 1.5 | 3.5 | 3.5 | 3.5 |
| Polymer | | | | | |
| Yield in g | 6.7 | 20.7 | 12.8 | 20.2 | 38.8 |
| Styrene content in mol. % | 5.3 | 18.9 | 10.4 | 29.8 | 37.9 |
| Butadiene content in mol. % | 94.7 | 81.1 | 89.6 | 70.2 | 62.1 |
| cis in % | 63 | 55 | 58 | 53 | 51 |
| trans in % | 32 | 41 | 35 | 38 | 41 |
| 1,2 in% | 5 | 4 | 7 | 10 | 8 |
| η (5% in styrene) in mPa · s | 5.95 | nd | nd | nd | nd |
| T_{g} in ° C. | −97.5 | nd | −92 | nd | nd |

nd = not determined.

### Example 6

Catalyst Ageing

Catalyst ageing proceeded in a similar manner to Examples 1 to 5.

Polymerisation

Polymerisation proceeded in a 6 litre glass jar equipped with an anchor stirrer, a reflux condenser connected to a cryostat set at a temperature of −30° C., a jacket connected to a thermostat, an internal thermometer, a septum and an argon connection. 292 g of liquid butadiene were added at 25° C. under argon to 1050 ml of styrene and 68.8 ml of aged catalyst solution were then added. Polymerisation was performed at 50° C. and terminated after 3 hours by adding 20 ml of acetone with 2 g of BKF.

The solids content of the polymer solution was 34%. The polymer is of the following composition: 29.0 mol. % styrene, 71.0 mol. % butadiene (with 54% 1,4-cis, 41% 1,4-trans, 5% 1,2 units), viscosity (5 wt. % in styrene) is 15.3 mPa·s, the glass transition temperature is −86° C.

### Examples 7-10

Catalyst Ageing

7.1 g of butadiene, 0.80 ml of pentamethylcyclopentadiene and 147 ml of a 10% solution of methylalumoxane in toluene (MAO) were added at 25° C. through a septum to 20 ml of a 0.245 molar solution of neodymium(III) versatate (NDV) in hexane in a 100 ml Schlenk tube, maintained at 50° C. with stirring for 2 hours and used for the polymerisation.

Polymerisation

Polymerisation was performed as in Examples 1-5, wherein different aluminium compounds were used as the scavenger. Table 2 shows the batch sizes, reaction conditions and the properties of the polymers obtained.

TABLE 2
Examples 7 to 10

| Example | 7 | 8 | 9 | 10 |
|---|---|---|---|---|
| Catalyst solution in ml | 2.19 | 3.28 | 5.47 | 7.29 |
| NDV in mmol. | 0.06 | 0.09 | 0.15 | 0.2 |
| Polymerisation | | | | |
| Styrene in ml | 100 | 100 | 100 | 75 |
| 1,3-butadiene in g | 10.2 | 15.4 | 25.8 | 21.8 |
| TIBA (1 molar) in ml | 0.6 | 0.9 | 1.5 | — |
| TMA (1 molar) in ml | — | — | — | — |
| Temperature in ° C. | 50 | 50 | 50 | 50 |
| Reaction time in h | 3.5 | 3.5 | 3.5 | 2 |
| Polymer | | | | |
| Yielding | 9.1 | 19.3 | 42.2 | 24.5 |
| Styrene content in mol. % | 22.6 | 29.0 | 44.8 | 20.4 |
| Butadiene content in mol. % | 77.4 | 71.0 | 55.2 | 79.6 |
| cis in % | 65 | 58 | 53 | 47 |
| trans in % | 27 | 34 | 39 | 45 |
| 1,2 in% | 8 | 8 | 8 | 9 |
| η (5% in styrene) in mPa · s | 12.6 | 15.2 | 15.6 | nd |
| T_{g} in ° C. | | −76.5 | nd | −78 |

### Examples 11-16

Catalyst Ageing

7.0 g of butadiene, 0.80 ml of pentamethylcyclopentadiene and 88 ml of a 10% solution of methylalumoxane in toluene (MAO) were added at 25° C. through a septum to 20 ml of a 0.245 molar solution of neodymium(III) versatate (NDV) in hexane in a 100 ml Schlenk tube, maintained at 50° C. with stirring for 2 hours and used for the polymerisation.

Polymerisation

Polymerisation proceeded in a 6 litre glass jar equipped with an anchor stirrer, a reflux condenser connected to a cryostat set at a temperature of −30° C., a jacket connected to a thermostat, an internal thermometer, a septum and an argon connection. Polymerisation proceeded in a similar manner to Example 8. Table 3 shows the batch sizes, polymerisation conditions and results.

TABLE 3
Examples 11 to 16

| Example | 11 | 12 | 13 | 14 | 15 | 16 |
|---|---|---|---|---|---|---|
| Catalyst solution in ml | 24.4 | 18.8 | 18.8 | 24.4 | 24.4 | 18.8 |
| NDV in mmol. | 1 | 0.77 | 0.77 | 1 | 1 | 0.77 |
| Polymerisation | | | | | | |
| Styrene in ml | 1300 | 2000 | 2000 | 3000 | 1300 | 2000 |
| 1,3-butadiene in g | 207 | 317 | 305 | 405 | 200 | 301 |
| MAO (1.66 molar) in ml | 12 | 4.8 | — | — | — | — |
| TMA (1 molar) in ml | — | — | 7.7 | 10 | — | — |
| TIBA (1 molar) in ml | — | — | — | — | 20 | 7.7 |
| Temperature in ° C. | 47 | 50 | 50 | 50 | 50 | 50 |
| Reaction time in h | 3 | 5 | 5 | 5 | 3 | 3.8 |
| Polymer | | | | | | |
| Yielding | 278 | 377 | 392. | 461 | 289 | 358 |
| Styrene content in mol. % | 39.8 | 24.2 | 24.9 | 23.4 | 37.9 | 53.6 |
| Butadiene content in mol. % | 60.2 | 75.8 | 75.1 | 76.6 | 62.1 | 46.4 |
| cis in % | 43 | 58 | 47 | 50 | 58 | 66 |
| trans in % | 48 | 33 | 44 | 41 | 34 | 23 |
| 1,2 in % | 9 | 9 | 9 | 9 | 8 | 10 |
| η (5% in styrene) in mPa · s | 20 | 32 | 44 | 37 | 10 | 26 |
| T_{g} in ° C. | −76.5 | nd | nd | nd | −77.0 | nd |

### Examples 17-19

Catalyst Ageing

5.3 g of butadiene, 1.88 ml of pentamethylcyclopentadiene and 217 ml of a 10% solution of methylalumoxane in toluene (MAO) were added at 25° C. through a septum to 38.4 ml of a 0.3125 molar solution of neodymium(III) versatate (NDV) in hexane in a 300 ml Schlenk tube, maintained at 50° C. with stirring for 2 hours and used for the polymerisation.

Polymerisation

Polymerisation proceeded in a 40 litre steel reactor with an anchor stirrer (50 rpm). A solution of trimethylaluminium in hexane as scavenger was added at room temperature to a solution of butadiene in styrene, the reaction solution adjusted to a temperature of 50° C. within 45 minutes and combined with the corresponding quantity of catalyst solution. The reaction temperature was maintained at 50° C. during the polymerisation. On completion of the reaction time, the polymer solution was transferred within 15 minutes into a second reactor (80 litre reactor, anchor stirrer, 50 rpm) and polymerisation shortstopped by adding 3410 g of butanone with 7.8 g of Vulkanox KB and 25.5 g of Irgafos TNPP. Unreacted butadiene was removed by reducing the pressure within the reactor at 50° C. to 200 mbar within 1 hour and to 100 mbar within 2 hours.

Table 4 shows the batch sizes, reaction conditions and the properties of the polymers obtained.

TABLE 4
Examples 17 to 19

| Example | 17 | 18 | 19 |
|---|---|---|---|
| Catalyst solution in ml | 166 | 161 | 161 |
| NDV in mmol. | 7.5 | 7.3 | 7.3 |
| Polymerisation | | | |
| Styrene in g | 18070 | 16890 | 17154 |
| Water content in ppm | 83 | 30 | 37 |
| 1,3-butadiene in g | 3003 | 3700 | 3703 |
| TMA (2 molar) in ml | 17 | 5.6 | 7 |
| Temperature in ° C. | 50 | 50 | 50 |
| Reaction time in h | 4.5 | 3.25 | 3 |
| Polymer | | | |
| Solids content in wt. % | 16.31 | 16.29 | 15.51 |
| Styrene content in mol. % | 25.8 | 15.6 | 13.6 |
| Butadiene content in mol. % | 74.2 | 84.4 | 86.4 |
| cis in % | 57 | 62 | 64 |
| trans in % | 35 | 29 | 26 |
| 1,2 in % | 8 | 9 | 10 |
| η (5% in styrene) in mPa · s | 46 | 59 | 78 |
| T_{g} in ° C. | −67 | −74 | −77 |
| Mₙ in kg/mol. | 242 | nd | nd |
| M_{w} in kg/mol. | 332 | nd | nd |

### Examples 20 to 25

Catalyst Ageing

7.2 g of butadiene, 0.57 ml of indene and 88.6 ml of a 10% solution of methylalumoxane in toluene (MAO) were added at 25° C. through a septum to 20 ml of a 0.245 molar solution of neodymium(III) versatate (NDV) in hexane in a 100 ml Schlenk tube, maintained at 50° C. with stirring for 2 hours and used for the polymerisation.

Polymerisation

Polymerisation proceeded in a 0.5 litre flask, which was provided with a crown cork with an integral septum. The stated quantity of liquid butadiene was added to the initially introduced styrene and a further component (α-methylstyrene, divinylbenzene or isoprene) under argon through a cannula and the stated quantities of the aged catalyst solution were then added with a syringe. The temperature during the polymerisation was established by a water bath. After the stated reaction time, the polymer was isolated by precipitating the polymer solution in methanol/BKF and dried for one day in a vacuum drying cabinet at 60° C. Table 5 shows the batch sizes, reaction conditions and the properties of the polymers obtained.

TABLE 5
Examples 20 to 25

| Example | 20 | 21 | 22 | 23 | 24 | 25 |
|---|---|---|---|---|---|---|
| Catalyst solution in ml | 1.23 | 1.23 | 1.23 | 1.23 | 1.23 | 1.23 |
| NDV in mmol. | 0.05 | 0.05 | 0.05 | 0.05 | 0.05 | 0.05 |
| Polymerisation | | | | | | |
| Styrene in ml | 100 | 100 | 100 | 100 | 100 | 100 |
| 1,3-butadiene in g | 21.1 | 22.8 | 22.3 | 23.6 | 25.1 | 21.5 |
| c-Methylstyrene | 5 | 20 | | | | |
| Divinylbenzene | 5 | 20 | | | | |
| Isoprene in ml | 5 | 20 | | | | |
| Temperature in ° C. | 50 | 50 | 50 | 50 | 50 | 50 |
| Reaction time in h | 2.5 | 2.5 | 2.5 | 2.5 | 0.5 | 0.5 |
| Polymer | | | | | | |
| Yielding | 15.2 | 10.5 | 9.1 | 9.6 | 12.3 | 23.6 |
| Styrene content in mol. % | nd | 11 | nd | 10 | nd 16 | |
| Butadiene content in mol. % | nd | 89 | nd | 90 | nd 84 | |
| cis in % | nd | 79 | nd | 77 | nd | nd |
| trans in % | nd | 15 | nd | 18 | nd | nd |
| 1,2 in % | nd | 6 | nd | 5 | nd | nd |

Patent claims

1. Process for the copolymerisation of conjugated diolefins with vinyl aromatic compounds, characterised in that polymerisation of the conjugated diolefins is performed in the presence of catalysts consisting of
a) at least one rare earth metal compound,
b) at least one cyclopentadienyl compound and
c) at least one organoaluminium compound or consisting of
a) at least one rare earth metal compound and
c) at least one organoaluminium compound
as well as in the presence of vinyl aromatic compounds at temperatures of −30 to +100° C., wherein the molar ratio of components (a):(b):(c) is in the range from 1:0.01-1.99:0.1-1000 or wherein the molar ratio of components (a):(c) is in the range from 1:0.1-1000, component (a) of the catalyst is used in quantities of 1 μmol. to 10 mmol., relative to 100 g of the conjugated diolefins used, and the aromatic vinyl compound is used in quantities of 50 g to 2000 g, relative to 100 g of the conjugated diolefins used.

2. Process according to claim 1, characterised in that the conjugated diolefins used are 1,3-butadiene, 1,3-isoprene, 2,3-dimethylbutadiene, 2,4-hexadiene, 1,3-pentadiene and/or 2-methyl- 1,3-pentadiene.

3. Process according to claims 1 and 2, characterised in that the rare earth metal compounds used are the alkoxides, phosphonates, phosphinates and carboxylates thereof as well as rare earth metal complex compounds with diketones and/or the addition compounds of rare earth metal halides with an oxygen or nitrogen donor compound.

4. Process according to claims 1 to 3 characterised in that the rare earth metal compounds used are neodymium versatate, neodymium octanoate and/or neodymium naphthenate.

5. Process according to claims 1 to 4, characterised in that the cyclopentadienes used are compounds of the formulae (I), (II) and/or (III) 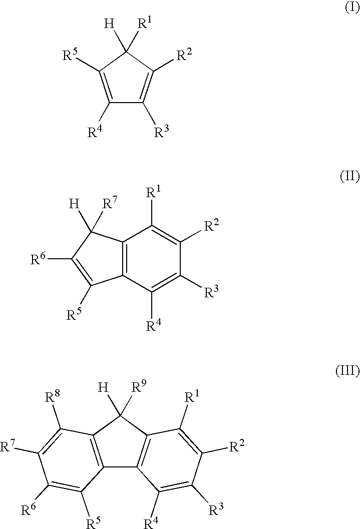
in which R¹ to R⁹ are identical or different or are optionally joined together or are fused on the cyclopentadiene of the formula (I), (II) or (III) and may denote hydrogen, a C₁-C₃₀ alkyl group, a C₆-C₁₀ aryl group, a C₇-C₄₀ alkylaryl group and a C₃-C₃₀ silyl group, wherein the alkyl groups may be either saturated or mono- or polyunsaturated and may contain heteroatoms.

6. Process according to claims 1 to 5, characterised in that the organoaluminium compounds used are alumoxanes and/or aluminiumorganyl compounds.

7. Process according to claims 1 to 6, characterised in that a conjugated diolefin is used as an additional component (d) in a quantity of 1 to 1000 mol., relative to 1 mol. of component (a).

8. Process according to claims 1 to 7 characterised in that the aromatic vinyl compounds used are styrene, α-methylstyrene, α-methylstyrene dimer, p-methylstyrene, divinylbenzene and/or alkylstyrenes having 2 to 6 C atoms in the alkyl residue.

9. Process according to claims 1 to 8, characterised in that, as well as the conjugated dienes, further unsaturated compounds which may be copolymerised with the stated diolefins are additionally used, specifically in quantities of 0.1 to 80 mol. %, relative to the conjugated diene used.
